(19) United States
(12) Patent Application Publication
(10) Pub. No.: US 2023/0043075 A1
(43) Pub. Date: Feb. 9, 2023

(54) RECEIVING-SIDE APPARATUS, IMAGE QUALITY IMPROVEMENT SYSTEM, AND IMAGE QUALITY IMPROVEMENT METHOD

(71) Applicant: Woven Planet Holdings, Inc., Tokyo (JP)

(72) Inventor: Toshinobu WATANABE, Tokyo-to (JP)

(73) Assignee: Woven Planet Holdings, Inc., Tokyo (JP)

(21) Appl. No.: 17/878,296

(22) Filed: Aug. 1, 2022

(30) Foreign Application Priority Data
Aug. 4, 2021 (JP) 2021-128563

(51) Int. Cl. G06T 5/00; H04N 7/18

(52) U.S. Cl. CPC G06T 5/001; H04N 7/183; G06T 2207/30252

(57) ABSTRACT

A receiving-side apparatus executes: reception processing for receiving a camera image from a transmitting-side apparatus; determination processing for determining whether execution conditions for performing image quality improvement processing with respect to the camera image are established; in a case where the execution conditions are established, order processing for transmitting the camera image to an external server apparatus connected through a network to the receiving-side apparatus, and ordering the image quality improvement processing with respect to the camera image; processing for receiving an image-quality-improved image generated by performing image quality improvement processing on the camera image from the external server apparatus; and processing for displaying the image-quality-improved image on a display apparatus.

### CROSS-REFERENCE TO RELATED APPLICATION

The present application claims priority under 35 U.S.C. § 119 to Japanese Patent Application No. 2021-128563, filed Aug. 4, 2021, the contents of which application are incorporated herein by reference in their entirety.

### BACKGROUND

### Field

The present disclosure relates to technology for improving the display image quality of a camera image.

### Background

Patent Literature 1 discloses technology for adjusting the image quality of images captured by a plurality of vehicle-mounted cameras. According to this technology, in a case where the line of sight of a driver who is remotely operating a vehicle changes, the line of sight information is transmitted to a telematics center. Based on the line of sight information and information regarding the arrangement of the vehicle-mounted cameras, the telematics center then calculates a bit rate for moving image imaging for each camera individually, and delivers an instruction for changing the bit rates to the vehicle.

Non Patent Literature 1 discloses “super resolution” technology which maps an inputted low-resolution image to a high-resolution image. In particular, in Non Patent Literature 1, SRCNN in which deep learning based on a convolutional neural network (CNN) is applied to super resolution (SR) is disclosed. A model that maps an inputted low-resolution image to a high-resolution image is obtained by machine learning.

Patent Literature 1: JP 2016-134816 A

Non Patent Literature 1: Chao Dong, Chen Change Loy, Kaiming He, and Xiaoou Tang, “Image Super-Resolution Using Deep Convolutional Networks”, arXiv:1501.00092v3 [cs.CV], Jul. 31, 2015 (https://arxiv.org/pdf/1501.00092.pdf)

### SUMMARY

In the technology disclosed in Patent Literature 1, the bit rates of vehicle-mounted cameras are changed on the vehicle side. Therefore, when taking full advantage of the latest software relating to changing bit rates is taken into consideration, there is a need to frequently update the hardware resources on the vehicle side. Therefore, when considering ways for improving the image quality of a camera image that is sent from a transmitting-side apparatus equipped with a camera to a receiving-side apparatus equipped with a display apparatus, one issue that needs to be taken into account is how to improve image quality while reducing the labor required for maintaining and managing the hardware resources.

The present disclosure has been made in consideration of the above problem, and an objective of the present disclosure is to provide technology that can improve the image quality of a camera image sent from a transmitting-side apparatus to a receiving-side apparatus while reducing the labor required for maintaining and managing the hardware resources.

To achieve the aforementioned objective, the present disclosure is applied to a receiving-side apparatus that receives a camera image transmitted from a transmitting-side apparatus. The receiving-side apparatus includes one or a plurality of memories which store one or a plurality of programs, and one or a plurality of processors which are coupled with the one or a plurality of memories. When executing the one or a plurality of programs, the one or a plurality of processors execute: reception processing for receiving the camera image from the transmitting-side apparatus; determination processing for determining whether or not execution conditions for performing image quality improvement processing with respect to the camera image are established; in a case where the execution conditions are established, order processing for transmitting the camera image to an external server apparatus that is connected through a communication network to the receiving-side apparatus, and ordering the image quality improvement processing with respect to the camera image; processing for receiving, from the external server apparatus, an image-quality-improved image that is generated by performing the image quality improvement processing on the camera image; and processing for displaying the image-quality-improved image on a display apparatus.

In the receiving-side apparatus according to the present disclosure, the one or a plurality of processors may be configured to, when executing the one or a plurality of programs, further execute: processing for displaying the camera image or visual range information pertaining to the camera image on the display apparatus, and processing for accepting a human request to perform image quality improvement processing with respect to the camera image; wherein, in the order processing, the one or a plurality of processors may be configured so that, in a case where the execution conditions are established, the one or a plurality of processors order the image quality improvement processing in a case where the human request is accepted.

The external server apparatus may be a cloud server in a cloud computing environment.

Further, in the present disclosure, the transmitting-side apparatus may be mounted in a vehicle that is subjected to remote monitoring by a remote operator at a remote location, and the camera image may include an image of an area around the vehicle that is required for the remote monitoring. Further, the receiving-side apparatus may include a remote monitoring server that is used for the remote monitoring by the remote operator.

In addition, in the receiving-side apparatus according to the present disclosure, the execution conditions may include a condition that is established when a delay time in a case where the image quality improvement processing is performed on the camera image is less than a threshold value which defines a predetermined allowable upper limit.

Further, to achieve the aforementioned objective, the present disclosure is applied to an image quality improvement system that improves image quality of a camera image. The image quality improvement system includes: a transmitting-side apparatus that transmits the camera image; a receiving-side apparatus that receives the camera image transmitted from the transmitting-side apparatus; and an external server apparatus that performs image quality improvement processing with respect to the camera image transmitted from the receiving-side apparatus, and transmits an image-quality-improved image generated by performing the image quality improvement processing to the receiving-side apparatus. The image quality improvement system is configured to execute: determination processing for determining whether or not execution conditions for performing image quality improvement processing with respect to the camera image are established; execution processing for, in a case where the execution conditions are established, executing the image quality improvement processing with respect to the camera image in the external server apparatus; and display processing for displaying an image-quality-improved image generated by performing the image quality improvement processing on the camera image, on a display apparatus.

The image quality improvement system of the present disclosure may be configured to further execute: processing for displaying the camera image or visual range information pertaining to the camera image on the display apparatus; and processing for accepting a human request to perform image quality improvement processing with respect to the camera image. Further, in the execution processing, the image quality improvement system may be configured to, in a case where the execution conditions are established, execute the image quality improvement processing in a case where the human request is also accepted.

Furthermore, the present disclosure is applied to an image quality improvement method for improving display image quality on a display apparatus of a camera image that is transmitted from a transmitting-side apparatus to a receiving-side apparatus. The receiving-side apparatus is connected through a communication network to an external server apparatus. The external server apparatus is configured to perform image quality improvement processing with respect to the camera image that is transmitted from the receiving-side apparatus, and to transmit an image-quality-improved image generated by performing the image quality improvement processing to the receiving-side apparatus. The image quality improvement method includes: a determination step of determining whether or not execution conditions for performing the image quality improvement processing are established; an execution step of, in a case where the execution conditions are established, executing the image quality improvement processing with respect to the camera image in the external server apparatus; and a display step of displaying an image-quality-improved image generated by performing the image quality improvement processing on the camera image, on the display apparatus.

Further, the image quality improvement method of the present disclosure may be configured to further include: a step of displaying the camera image or visual range information pertaining to the camera image on the display apparatus; and a step of accepting a human request to perform the image quality improvement processing with respect to the camera image. In this case, in the execution step, the image quality improvement method may be configured to, in a case where the execution conditions are established, execute the image quality improvement processing in a case where the human request is accepted again.

According to the present disclosure, in a case where execution conditions for performing image quality improvement processing on a received camera image are established, an order is placed with an external server, which is connected through a communication network, to perform the image quality improvement processing. By this means, a receiving-side apparatus can display an image-quality-improved image without the receiving-side apparatus itself performing image quality improvement processing, and hence it is possible to improve the image quality of a camera image that is sent from a transmitting-side apparatus to a receiving-side apparatus while reducing labor required for maintenance and management of hardware resources.

Further, according to the present disclosure, acceptance processing for accepting a human request to perform image quality improvement processing with respect to a camera image is executed. By this means, it is possible to make a determination as to whether or not image quality improvement processing is required by referring to a camera image displayed on a display apparatus.

In addition, according to the present disclosure, since image quality improvement processing is performed by a cloud server, labor required for maintenance and management of hardware resources of the receiving-side apparatus can be reduced.

Further, according to the present disclosure, image quality improvement processing is performed with respect to an image of an area around a vehicle that is being subjected to remote monitoring by a remote operator. By this means, the accuracy of the remote monitoring of the vehicle improves.

Further, according to the present disclosure, when a delay time in a case where image quality improvement processing is performed on a camera image is less than a threshold value that defines a predetermined allowable upper limit, an execution condition for ordering the image quality improvement processing is established. Thus, a situation does not arise in which image quality improvement processing is ordered under circumstances in which a delay time exceeds the threshold value, and therefore the occurrence of a delay that arises as a result of ordering image quality improvement processing can be suppressed.

### BRIEF DESCRIPTION OF DRAWINGS

FIG. 1 is a conceptual diagram illustrating an outline of an image quality improvement system 100A according to an embodiment;

FIG. 2 illustrates a remote monitoring system 100 that is an application example of the image quality improvement system 100A;

FIG. 3 is a block diagram illustrating the configuration of a vehicle 10 equipped with an in-vehicle information processing apparatus 20 according to the embodiment;

FIG. 4 is a block diagram illustrating the configuration of a remote monitoring center 30 in which a remote monitoring server 40 is installed according to the embodiment;

FIG. 5 is a block diagram illustrating an example of the functional configuration of the remote monitoring server 40 according to an image quality improvement method of the embodiment; and

FIG. 6 is a flowchart illustrating a flow of processing in the image quality improvement method that is performed by a remote monitoring system according to the embodiment.

### DETAILED DESCRIPTION

An embodiment of the present disclosure is described hereunder with reference to the accompanying drawings. However, it is to be understood that even when the number, quantity, amount, range or other numerical attribute of an element is mentioned in the following description of the embodiment, the technical idea pertaining to the present disclosure is not limited to the mentioned numerical attribute unless it is expressly stated or theoretically defined.

1. Image Quality Improvement System

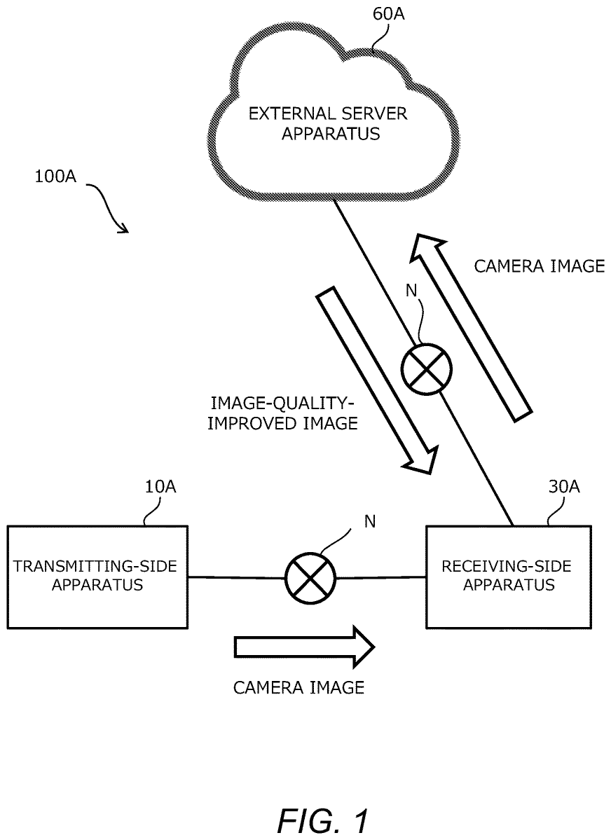

FIG. 1 is a conceptual diagram illustrating an outline of an image quality improvement system 100A according to the present embodiment. The image quality improvement system 100A includes a transmitting-side apparatus 10A, a receiving-side apparatus 30A, an external server apparatus 60A and a communication network N. The transmitting-side apparatus 10A and the receiving-side apparatus 30A are connected to each other through the communication network N. The transmitting-side apparatus 10A and the receiving-side apparatus 30A are capable of communicating with each other through the communication network N. For example, the transmitting-side apparatus 10A and the receiving-side apparatus 30A conduct radio communication. However, the present embodiment is not limited to radio communication, and the communication may be wired communication.

The transmitting-side apparatus 10A is, for example, mounted in a moving body. Examples of the moving body that may be mentioned include a vehicle, a robot, and a flying body. The vehicle may be a self-driving vehicle, or may be a vehicle which is driven by a driver. Examples of the robot that may be mentioned include a distribution robot and a work robot. Examples of the flying body that may be mentioned include an airplane and a drone. Alternatively, the transmitting-side apparatus 10A is mounted in a surveillance camera apparatus. The surveillance camera apparatus, for example, is installed at the entrance to a facility or at an outdoor facility.

The receiving-side apparatus 30A is an external apparatus that conducts communication with the transmitting-side apparatus 10A. For example, in a case where the transmitting-side apparatus 10A is a moving body, the receiving-side apparatus 30A includes a monitoring server that remotely monitors the moving body, and a display apparatus.

The transmitting-side apparatus 10A obtains a camera image from a camera, and transmits the camera image to the receiving-side apparatus 30A. The camera image is transmitted to the receiving-side apparatus 30A through the communication network N. The receiving-side apparatus 30A receives the camera image, and outputs the received camera image to the display apparatus.

The receiving-side apparatus 30A and the external server apparatus 60A are connected to each other through the communication network N. The receiving-side apparatus 30A and the external server apparatus 60A are capable of communicating with each other through the communication network N. For example, the receiving-side apparatus 30A and the external server apparatus 60A conduct radio communication. However, the present embodiment is not limited to radio communication.

The external server apparatus 60A is, for example, a cloud server in a cloud computing environment. Alternatively, the external server apparatus 60A is an on-premises server that is operated by the relevant company itself. The external server apparatus 60A obtains the camera image from the receiving-side apparatus 30A, and performs image quality improvement processing on the camera image. The camera image after the image quality improvement processing is referred to hereunder as “image-quality-improved image”. The image-quality-improved image is transmitted to the receiving-side apparatus 30A. The receiving-side apparatus 30A receives the image-quality-improved image, and outputs the received image-quality-improved image to the display apparatus.

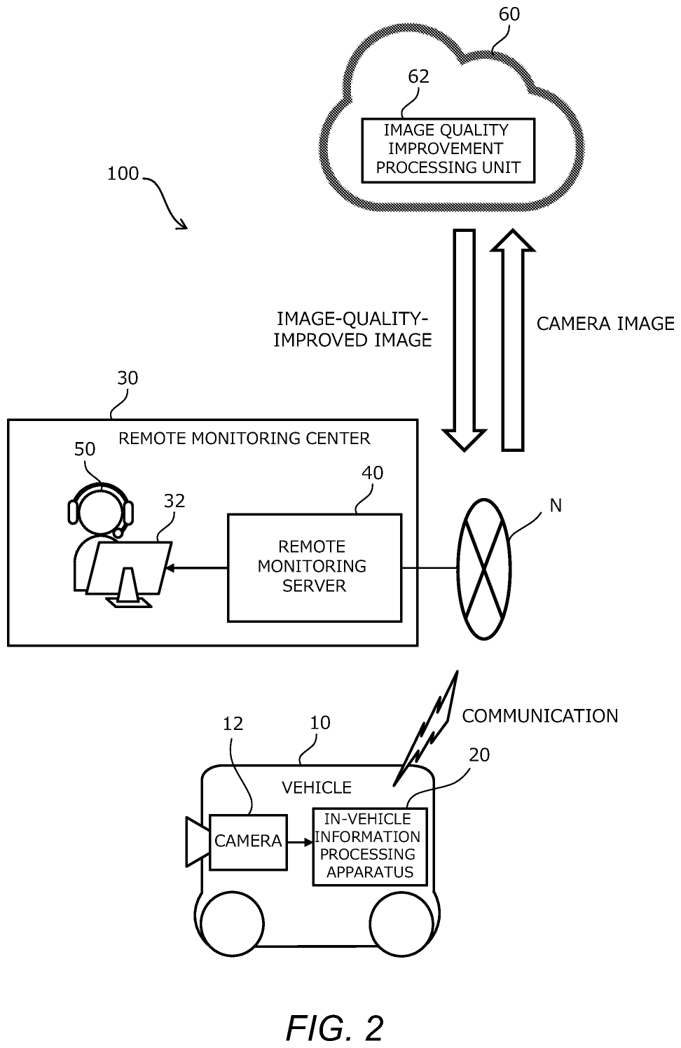

FIG. 2 illustrates a remote monitoring system 100 that is an application example of the image quality improvement system 100A. The remote monitoring system 100 includes a vehicle 10 as an application example of the transmitting-side apparatus 10A, a remote monitoring center 30 as an application example of the receiving-side apparatus 30A, and a cloud server 60 as the external server apparatus 60A. The vehicle 10 may be an autonomous driving vehicle.

The remote monitoring system 100 is a system in which the vehicle 10 travelling on a road is remotely monitored by a remote operator 50 at a remote location. The remote monitoring in the present disclosure includes monitoring for remote driving of the vehicle 10, monitoring for remote support according to the circumstances of the vehicle 10 that is autonomously driving, and monitoring for checking the surrounding environment of the vehicle 10 that is autonomously driving.

The vehicle 10 that is the object of the remote monitoring is equipped with a camera 12. The camera 12 may be a stereoscopic camera or may be a monocular camera. For example, the camera 12 captures an image of an area around the vehicle 10.

The vehicle 10 is equipped with an in-vehicle information processing apparatus 20. A camera image captured by the camera 12 is input to the in-vehicle information processing apparatus 20. The in-vehicle information processing apparatus 20 is connected through the communication network N to a remote monitoring server 40 of the remote monitoring center 30. The communication network N includes cellular communication such as 4G or 5G. The camera image captured by the camera 12 is sent from the in-vehicle information processing apparatus 20 to the remote monitoring server 40 through the communication network N.

At the remote monitoring center 30, the camera image captured by the camera 12 that is sent from the in-vehicle information processing apparatus 20 to the remote monitoring server 40 is displayed on a monitoring screen of a display apparatus 32. For example, a liquid crystal display, an organic electroluminescence display, a head-mounted display or a touch panel can be used as the display apparatus 32. The remote operator 50 can monitor the area in front of the vehicle 10 by means of the camera image of the camera 12 that appears on the monitoring screen of the display apparatus 32.

Here, with regard to the remote monitoring system 100, in order for the remote operator 50 to check the camera image, it is required for an image captured by the camera 12 to have a high degree of visibility. However, it is not easy to always maintain hardware such as the camera 12 in an up-to-date state. Therefore, from the viewpoint of the hardware, constraints arise with respect to the visibility of the camera image of the camera 12. In particular, the aforementioned problem of visibility arises more noticeably when the environmental conditions are such that it is difficult to capture a clear camera image, such as during bad weather or at night.

3. Outline of Features of Remote Monitoring System

In the remote monitoring system 100, the aforementioned problem is solved as follows. That is, the remote monitoring system 100 includes the cloud server 60 for performing image quality improvement processing on the camera image. When the cloud server 60 receives an order from the remote monitoring server 40, the cloud server 60 executes image quality improvement processing for improving the display image quality of the camera image. Typically, the remote monitoring server 40 places an order with the cloud server 60 to perform image quality improvement processing in a case where either one of, or both of, the following execution conditions are established:

(a) A delay time until displaying an image in a case where image quality improvement processing is executed does not exceed a threshold value of an allowable upper limit time; and

(b) A total cost required for image quality improvement processing does not exceed a threshold value of an allowable upper limit cost.

In addition, the remote monitoring server 40 may add a determination made by the remote operator 50 as to whether or not image quality improvement processing is required to the execution conditions. Typically, the remote operator 50 refers to the camera image displayed on the display apparatus 32 and determines whether or not image quality improvement processing is required. If the remote operator 50 determines that image quality improvement processing is required, the remote operator 50 inputs the determination to that effect to an input apparatus.

For example, super-resolution technology that uses an image quality improving model is utilized for the image quality improvement processing. The cloud server 60 includes an image quality improvement processing unit 62. The image quality improvement processing unit 62 applies super-resolution technology to the received camera image to improve the image quality. Super-resolution technology can map an input low-resolution image to a high-resolution image. Note that, various techniques which utilize various image quality improving models such as resolution enhancement, darkness improvement, backlight improvement, rain removal, fog removal, and blur prevention have been proposed as techniques of the super-resolution technology (for example, see Non Patent Literature 1). In the present embodiment, a technique of the super-resolution technology that is utilized for the image quality improvement processing is not particularly limited.

The image quality improvement processing unit 62 generates an image-quality-improved image by applying super-resolution technology to the camera image. The generated image-quality-improved image is transmitted to the remote monitoring server 40. The remote monitoring server 40 displays the received image-quality-improved image on the display apparatus 32. By this means, an improved image that has higher image quality than the camera image is obtained, and therefore it becomes easier for the remote operator 50 to accurately ascertain the circumstances in the area around the vehicle 10. As a result, the remote monitoring accuracy improves.

4. Detailed Configuration and Functions of Remote Monitoring System 100

Next, the detailed configuration and functions of the remote monitoring system 100 that is an application example of the image quality improvement system 100A is described. As described in the following, the remote monitoring system 100 is technically designed so as to improve the image quality of a camera image displayed on the display apparatus 32.

4-1. Configuration Example of Vehicle According to Present Embodiment

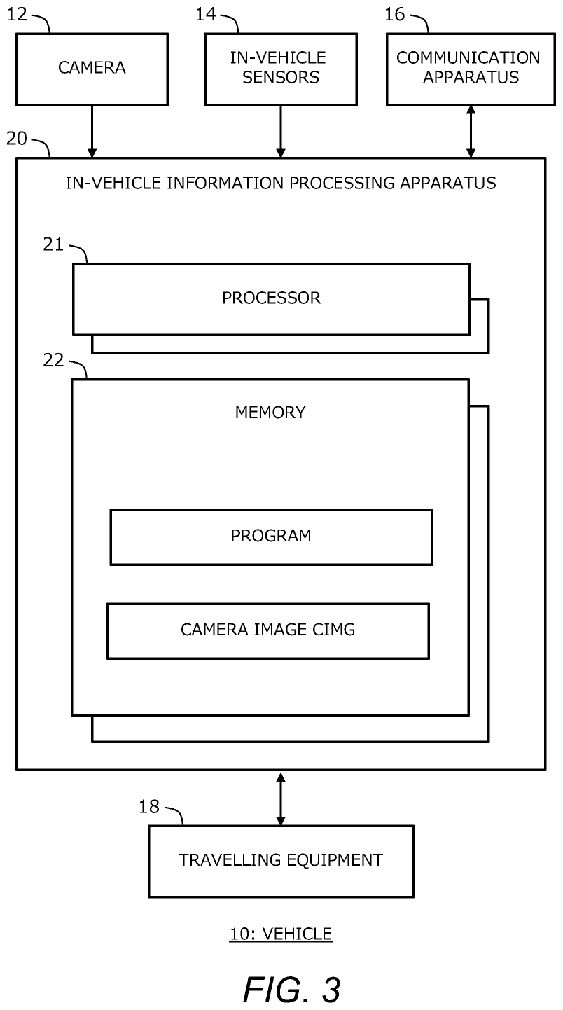

FIG. 3 is a block diagram illustrating the configuration of the vehicle 10 equipped with the in-vehicle information processing apparatus 20 according to the present embodiment. The vehicle 10 is equipped with the camera 12, in-vehicle sensors 14, a communication apparatus 16, travelling equipment 18, and the in-vehicle information processing apparatus 20. The details regarding the camera 12 which the vehicle 10 is equipped with are as described in the foregoing.

The in-vehicle sensors 14 include a state sensor that obtains information relating to driving of the vehicle 10. The state sensor, for example, includes at least one of a speed sensor, an acceleration sensor, a yaw rate sensor, and a steering angle sensor. Further, the in-vehicle sensors 14 include a position sensor that detects the position and direction of the vehicle 10. A GPS (Global Positioning System) sensor is mentioned as an example of the position sensor. The in-vehicle sensors 14 may also include a recognition sensor other than the camera 12. A recognition sensor recognizes (detects) the circumstances in the area around the vehicle 10. A LiDAR (Laser Imaging Detection and Ranging) sensor, a millimeter wave radar sensor, and an ultrasound sensor may be mentioned as examples of a recognition sensor.

The communication apparatus 16 conducts communication with the outside of the vehicle 10. The communication apparatus 16 conducts communication with the remote monitoring server 40 through the communication network N.

The travelling equipment 18 includes a steering apparatus for steering the vehicle 10, a driving apparatus for driving the vehicle 10, and a braking apparatus for causing the vehicle 10 to decelerate. Examples of the steering apparatus include a power steering system, a steer-by-wire steering system, and a rear wheel steering system. Examples of the driving apparatus include an engine, an EV system, and a hybrid system. Examples of the braking apparatus include a hydraulic brake and a regenerative brake.

The in-vehicle information processing apparatus 20 is an ECU (Electronic Control Unit) or a set of a plurality of ECUs mounted in the vehicle 10. The in-vehicle information processing apparatus 20 includes one or a plurality of processors 21 (hereinafter, referred to simply as “processor 21”), and one or a plurality of memories 22 (hereinafter, referred to simply as “memory 22”) coupled with the processor 21. A program that is executable by the processor 21 and various information related to the program are stored in the memory 22. When the processor 21 executes the program, various kinds of processing are realized by the processor 21.

The processor 21 stores a camera image CIMG captured by the camera 12 in the memory 22. The processor 21 transmits the camera image CIMG to the remote monitoring server 40 using the communication apparatus 16.

4-2. Configuration Example of Remote Monitoring Center According to Present Embodiment

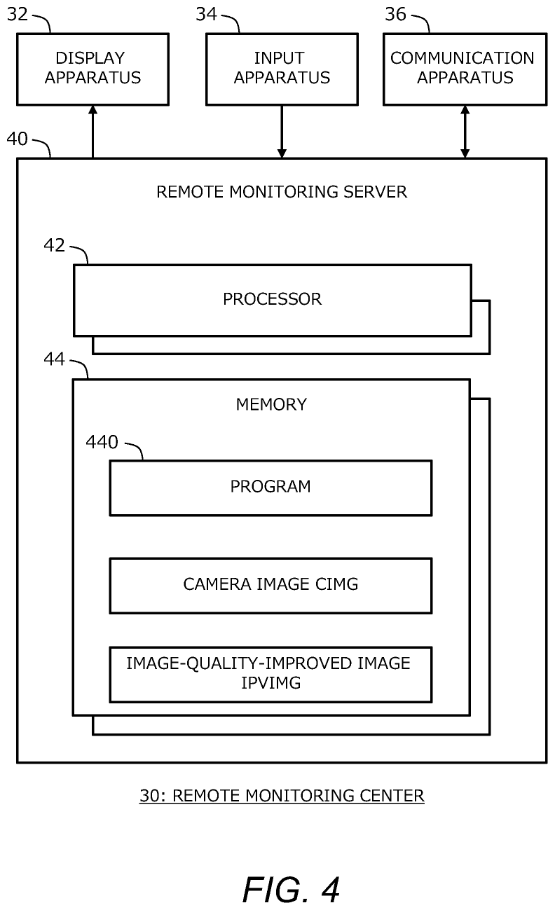

FIG. 4 is a block diagram illustrating the configuration of the remote monitoring center 30 in which the remote monitoring server 40 is installed according to the present embodiment. In addition to the remote monitoring server 40 and the display apparatus 32, an input apparatus 34 and a communication apparatus 36 are provided in the remote monitoring center 30. Similarly to the display apparatus 32, the input apparatus 34 and the communication apparatus 36 are connected to the remote monitoring server 40.

The input apparatus 34 is an interface for accepting input operations from the remote operator 50. A touch panel, a keyboard, and a mouse can be mentioned as examples of the input apparatus 34. The communication apparatus 36 conducts communication with the outside of the vehicle 10. The communication apparatus 36 conducts communication with the in-vehicle information processing apparatus 20 and the cloud server 60 through the communication network N.

The remote monitoring server 40 is a computer or a set of a plurality of computers arranged in the remote monitoring center 30. The remote monitoring server 40 includes one or a plurality of processors 42 (hereinafter, referred to simply as “processor 42”) and one or a plurality of memories 44 (hereinafter, referred to simply as “memory 44”) coupled with the processor 42. The memory 44 includes a main memory and an auxiliary memory. A program 440 that is executable by the processor 42 and various information related to the program are stored in the memory 44. When the processor 42 executes the program 440, various kinds of processing are realized by the processor 42. The program 440 can be stored in the main memory, or can be stored in a computer-readable recording medium that is the auxiliary memory.

The processor 42 stores the camera image CIMG obtained from the vehicle 10 through the communication apparatus 36 in the memory 44. Further, the processor 42 stores an image-quality-improved image IPVIMG obtained from the cloud server 60 through the communication apparatus 36 in the memory 44.

4-3. Example of Functional Configuration of Remote Monitoring Server 40

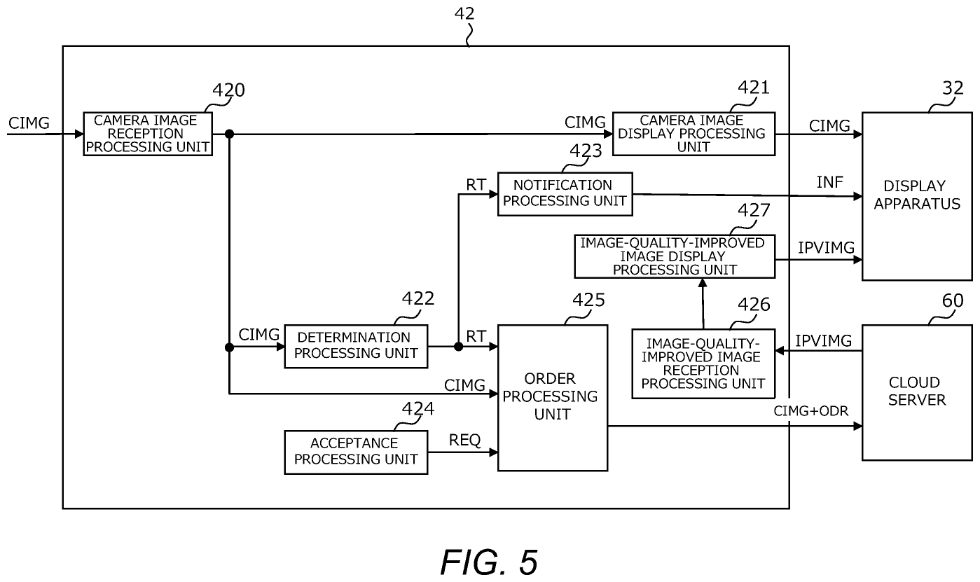

FIG. 5 is a block diagram illustrating an example of the functional configuration of the remote monitoring server 40 according to the image quality improvement method of the present embodiment. As functional blocks which are realized by the processor 42 executing the program 440, the remote monitoring server 40 includes a camera image reception processing unit 420, a camera image display processing unit 421, a determination processing unit 422, a notification processing unit 423, an acceptance processing unit 424, an order processing unit 425, an image-quality-improved image reception processing unit 426, and an image-quality-improved image display processing unit 427.

The camera image reception processing unit 420 receives the camera image CIMG through the communication apparatus 36, and stores the camera image CIMG in the memory 44. The received camera image CIMG is read out in response to requests from the camera image display processing unit 421, the determination processing unit 422, and the order processing unit 425.

The camera image display processing unit 421 outputs the received camera image CIMG to the display apparatus 32. The display apparatus 32 is referred to by the remote operator 50.

The determination processing unit 422 is a functional block for determining whether or not execution conditions for executing image quality improvement processing are established. Typically the determination processing unit 422 determines whether or not the received camera image CIMG requires image quality improvement processing. Here, in a case where image quality improvement processing of the camera image CIMG is executed at the cloud server 60, the determination processing unit 422 calculates a delay time T until an image-quality-improved image IPVIMG will be displayed on the display apparatus 32. Here, the delay time T is estimated based on the image quality improving model and arithmetic capability of image quality improvement processing executed at the cloud server 60. A method for estimating the delay time T is not limited. The determination processing unit 422 determines whether or not the estimated delay time T exceeds a predetermined threshold value Tth. Here, a value (for example, 200 ms) that was previously determined as the upper limit value of the delay time T that is allowable for the camera image that the remote operator 50 refers to is utilized as the threshold value Tth. The threshold value Tth may be a fixed value or may be a variable that varies according to the visual range from the vehicle 10 or the vehicle speed. A determination result signal RT generated in the determination processing unit 422 is sent to the notification processing unit 423 and the order processing unit 425.

In a case where the determination result signal RT obtained from the determination processing unit 422 is a determination result indicating that the delay time T exceeds the threshold value Tth, the notification processing unit 423 notifies the remote operator 50 to the effect that the delay time T exceeds the threshold value. The form of the notification in this case is not limited. Typically the notification processing unit 423 generates threshold value exceeded information INF which indicates the threshold value is exceeded, and outputs the threshold value exceeded information INF to the display apparatus 32.

The acceptance processing unit 424 accepts a human request from the remote operator 50 with respect to placement of an order with the cloud server 60 to perform image quality improvement processing. Typically, the remote operator 50 refers to the camera image displayed on the display apparatus 32 and determines whether or not image quality improvement processing is required. Alternatively, in a case where information relating to the visual range of the camera image is being displayed on the display apparatus 32, the remote operator 50 refers to the visual range information that is displayed and determines whether or not image quality improvement processing is required. Here, a rank value of the visual range of the camera image, a rank value of the brightness of the camera image and the like may be mentioned as examples of the visual range information. If the remote operator 50 determines that image quality improvement processing is required, the remote operator 50 operates the input apparatus 34 to input a human request. The input method used by the remote operator 50 is not limited. For example, the remote operator 50 clicks on a request button for requesting image quality improvement processing that is displayed on the display apparatus 32. A request signal REQ for image quality improvement processing generated as a result of the input by the remote operator 50 is sent to the order processing unit 425.

In a case where the determination result signal RT obtained from the determination processing unit 422 is a determination result indicating that the delay time T does not exceed the threshold value Tth, and the request signal REQ is obtained from the acceptance processing unit 424, the order processing unit 425 places an order with the cloud server 60 to perform image quality improvement processing. Typically, the order processing unit 425 sends an order signal ODR for image quality improvement processing and the camera image CIMG to the cloud server 60.

The cloud server 60 generates an image-quality-improved image IPVIMG by performing image quality improvement processing on the camera image CIMG in the image quality improvement processing unit 62. The generated image-quality-improved image IPVIMG is sent to the image-quality-improved image reception processing unit 426.

The image-quality-improved image reception processing unit 426 receives the image-quality-improved image IPVIMG through the communication apparatus 36. The received image-quality-improved image IPVIMG is sent to the image-quality-improved image display processing unit 427.

The image-quality-improved image display processing unit 427 outputs the image-quality-improved image IPVIMG received from the image-quality-improved image reception processing unit 426 to the display apparatus 32. The display apparatus 32 is referred to by the remote operator 50.

4. Specific Example of Application of Image Quality Improvement Method by Remote Monitoring System 100

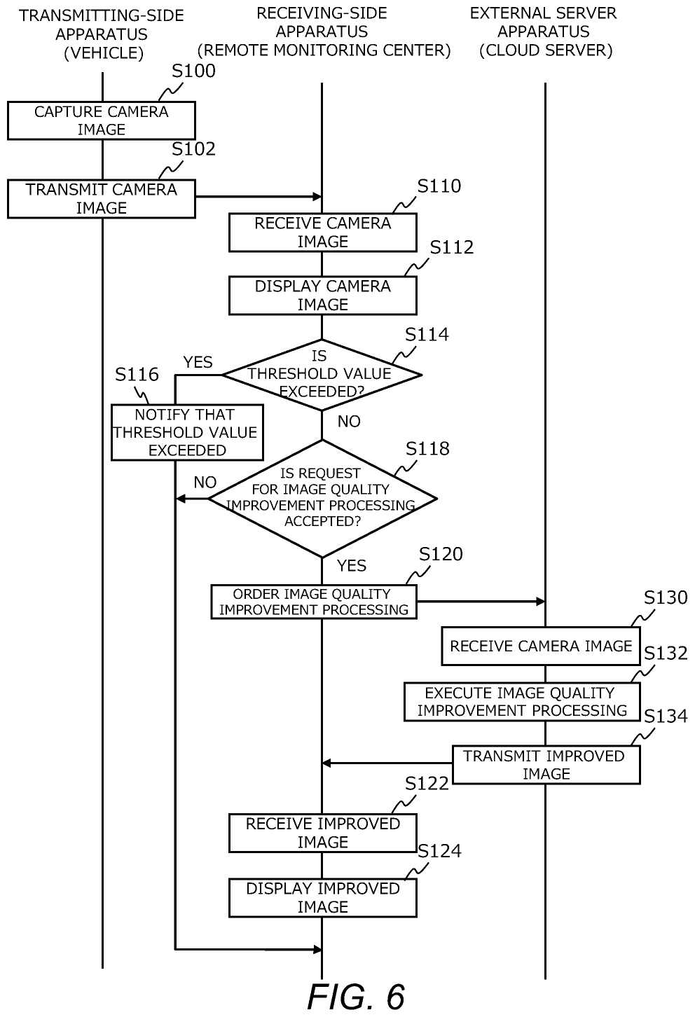

Next, an example of application of the image quality improvement method by the remote monitoring system 100 according to the present embodiment is described using FIG. 6. FIG. 6 is a flowchart illustrating the flow of processing of the image quality improvement method carried out by the remote monitoring system according to the present embodiment.

First, the processing in steps S100 and S102 is processing executed in the vehicle 10. In step S100, a camera image CIMG is captured using the camera 12. Next, in step S102, the captured camera image CIMG is sent to the remote monitoring server 40 through the communication network N.

Next, the processing from step S110 to step S124 is processing executed in the remote monitoring server 40. In step S110, the camera image CIMG is received by the camera image reception processing unit 420. The received camera image CIMG is stored in the memory 44. Next, in step S112, the camera image CIMG is displayed on the display apparatus 32 by the camera image display processing unit 421.

In step S114, the determination processing unit 422 determines whether or not the delay time T exceeds the threshold value Tth. If the result of the determination is that the delay time T exceeds the threshold value Tth, the processing advances to step S116. In step S116, the notification processing unit 423 notifies the remote operator 50 to the effect that the delay time exceeds the threshold value. When the processing in step S116 is completed, all steps thereafter are skipped and the processing at the remote monitoring server 40 is ended.

On the other hand, if the result of the determination in step S114 is that the delay time T does not exceed the threshold value Tth, the processing advances to step S118. In step S118 it is determined whether or not a human request for image quality improvement processing has been received. Here, it is determined whether or not the request signal REQ has been sent from the acceptance processing unit 424 to the order processing unit 425.

If the result of the determination in step S118 is that a human request for image quality improvement processing has not been received, all steps thereafter are skipped and the processing at the remote monitoring server 40 is ended. On the other hand, if a human request for image quality improvement processing has been received, the processing advances to step S120.

In step S120, at the order processing unit 425, the order processing unit 425 sends an order signal ODR for image quality improvement processing and the camera image CIMG to the cloud server 60.

The processing from step S130 to step S134 is processing that is executed at the cloud server 60. In step S130, the cloud server 60 receives the camera image CIMG. In step S132, the image quality improvement processing unit 62 of the cloud server 60 generates an image-quality-improved image IPVIMG by performing image quality improvement processing on the camera image CIMG. In step S134, the cloud server 60 transmits the generated image-quality-improved image IPVIMG to the remote monitoring server 40.

The processing transitions to processing at the remote monitoring server 40 once again, and in step S122 the image-quality-improved image IPVIMG is received by the image-quality-improved image reception processing unit 426. The received image-quality-improved image IPVIMG is stored in the memory 44. Next, in step S124, the image-quality-improved image IPVIMG is displayed on the display apparatus 32 by the image-quality-improved image display processing unit 427. Upon the processing in step S124 being performed, the processing at the remote monitoring server 40 is ended.

As will be clear from the above description, according to the remote monitoring system 100 to which the image quality improvement system 100A of the present embodiment is applied, an image-quality-improved image IPVIMG with respect to the camera image CIMG can be generated by image quality improvement processing utilizing the cloud server 60, and displayed on the display apparatus 32. As a result, it is possible to improve the image quality of the camera image that is sent from the vehicle 10 while reducing the labor required for maintenance and management of hardware resources constituting the camera 12 of the vehicle 10 and the remote monitoring server 40.

5. Modification

The image quality improvement system 100A according to the present embodiment may be modified as described below.

5-1. Image Quality Improvement System 100A

A system to which the image quality improvement system 100A can be applied is not limited to the remote monitoring system 100. That is, the image quality improvement system 100A can be applied to a wide range of systems which are equipped with the transmitting-side apparatus 10A equipped with a camera, the receiving-side apparatus 30A that displays a camera image, and the external server apparatus 60A that carries out image quality improvement processing in response to an order from the receiving-side apparatus 30A. Apart from the remote monitoring system 100 of a moving body, a security system that monitors a camera image from a security camera that is fixedly installed can be mentioned as an example of such kind of system.

5-2. External Server Apparatus 60A

The external server apparatus 60A is not limited to a cloud server, and may be an on-premises server.

5-3. Determination Processing Unit 422

Instead of, or in addition to, a determination as to whether the delay time T exceeds a threshold value, the determination processing unit 422 may make a determination with respect to a total cost TC that is required in a case where image quality improvement processing of the camera image CIMG is executed at the cloud server 60. Here, the total cost TC is an integrated value for a prescribed period (for example, one month) for service usage charges for image quality improvement processing at the cloud server 60 and communication charges and the like. The determination processing unit 422 estimates the total cost TC based on the kind of image quality improving model and the arithmetic capability of the cloud server 60. The method for estimating the total cost TC is not limited. The determination processing unit 422 determines whether the estimated total cost TC exceeds a predetermined threshold value TCth. Here, the threshold value TCth is a cost upper limit value for a prescribed period, and for example a value that is previously set by the remote operator 50 is utilized as the threshold value TCth. A determination result signal RT generated by the determination processing unit 422 is sent to the notification processing unit 423 and the order processing unit 425. According to such processing by the determination processing unit 422, image quality improvement processing can be ordered within a range in which the total cost TC can be kept lower than the threshold value TCth.

5-4. Acceptance Processing Unit 424

The functional configuration of the acceptance processing unit 424 is not essential. That is, a human request from the remote operator 50 is not essential with respect to a determination as to whether or not image quality improvement processing is required. In this case, it suffices for the order processing unit 425 to skip the processing corresponding to step S118 in the flowchart illustrated in FIG. 6, and to determine whether or not image quality improvement processing is required based only on the determination result signal RT obtained from the determination processing unit 422.

5-5. Order Processing Unit 425

Among the processing operations executed at the order processing unit 425, the sequence in which the processing corresponding to step S114 and the processing corresponding to step S118 in the flowchart illustrated in FIG. 6 are executed is not limited.

What is claimed is:

1. A receiving-side apparatus that receives a camera image transmitted from a transmitting-side apparatus,
the receiving-side apparatus comprising:
one or a plurality of memories that store one or a plurality of programs, and
one or a plurality of processors coupled with the one or a plurality of memories,
wherein:
when executing the one or a plurality of programs, the one or a plurality of processors execute:
reception processing for receiving the camera image from the transmitting-side apparatus;
determination processing for determining whether or not execution conditions for performing image quality improvement processing with respect to the camera image are established;
in a case where the execution conditions are established, order processing for transmitting the camera image to an external server apparatus that is connected through a communication network to the receiving-side apparatus, and ordering the image quality improvement processing with respect to the camera image;
processing for receiving, from the external server apparatus, an image-quality-improved image that is generated by performing the image quality improvement processing on the camera image; and
processing for displaying the image-quality-improved image on a display apparatus.

2. The receiving-side apparatus according to claim 1, wherein:
the one or a plurality of processors are configured to, when executing the one or a plurality of programs, further execute:
processing for displaying the camera image or visual range information pertaining to the camera image on the display apparatus, and
processing for accepting a human request to perform image quality improvement processing with respect to the camera image;
wherein, in the order processing, the one or a plurality of processors are configured so that:
in a case where the execution conditions are established, the one or a plurality of processors order the image quality improvement processing in a case where the human request is accepted.

3. The receiving-side apparatus according to claim 1, wherein:
the external server apparatus is a cloud server in a cloud computing environment.

4. The receiving-side apparatus according to claim 1, wherein:
the transmitting-side apparatus is mounted in a vehicle that is subjected to remote monitoring by a remote operator at a remote location;
the camera image includes an image of an area around the vehicle that is required for the remote monitoring; and
the receiving-side apparatus includes a remote monitoring server that is used for the remote monitoring by the remote operator.

5. The receiving-side apparatus according to claim 1, wherein:
the execution conditions include a condition that is established when a delay time in a case where the image quality improvement processing is performed on the camera image is less than a threshold value which defines a predetermined allowable upper limit.

6. An image quality improvement system that improves image quality of a camera image, comprising:
a transmitting-side apparatus that transmits the camera image;
a receiving-side apparatus that receives the camera image transmitted from the transmitting-side apparatus; and
an external server apparatus that performs image quality improvement processing with respect to the camera image transmitted from the receiving-side apparatus, and transmits an image-quality-improved image generated by performing the image quality improvement processing to the receiving-side apparatus;
wherein the image quality improvement system is configured to execute:
determination processing for determining whether or not execution conditions for performing image quality improvement processing with respect to the camera image are established;
execution processing for executing the image quality improvement processing with respect to the camera image in the external server apparatus in a case where the execution conditions are established; and
display processing for displaying an image-quality-improved image generated by performing the image quality improvement processing on the camera image, on a display apparatus.

7. The image quality improvement system according to claim 6, wherein:
the image quality improvement system is configured to further execute:
processing for displaying the camera image or visual range information pertaining to the camera image on the display apparatus, and
processing for accepting a human request to perform image quality improvement processing with respect to the camera image;
and wherein, in the execution processing, the image quality improvement system is configured to:
in a case where the execution conditions are established, execute the image quality improvement processing in a case where the human request is also accepted.

8. An image quality improvement method for improving display image quality on a display apparatus of a camera image that is transmitted from a transmitting-side apparatus to a receiving-side apparatus, wherein:
the receiving-side apparatus is connected through a communication network to an external server apparatus;
the external server apparatus is configured to perform image quality improvement processing with respect to the camera image that is transmitted from the receiving-side apparatus, and to transmit an image-quality-improved image generated by performing the image quality improvement processing to the receiving-side apparatus;
the image quality improvement method comprising:
a determination step of determining whether or not execution conditions for performing the image quality improvement processing are established;
an execution step of, in a case where the execution conditions are established, executing the image quality improvement processing with respect to the camera image in the external server apparatus; and
a display step of displaying an image-quality-improved image generated by performing the image quality improvement processing on the camera image, on the display apparatus.

9. The image quality improvement method according to claim 8, further comprising:
a step of displaying the camera image or visual range information pertaining to the camera image on the display apparatus, and
a step of accepting a human request to perform the image quality improvement processing with respect to the camera image,
wherein, in the execution step, the image quality improvement method is configured to:
in a case where the human request is accepted and the execution conditions are established, execute the image quality improvement processing in a case where the human request is accepted again.
